(19) United States
(12) Patent Application Publication
(10) Pub. No.: US 2024/0415251 A1
(43) Pub. Date: Dec. 19, 2024

(54) HEAT INSULATION OF A WRIST WATCH IN A SAUNA

(71) Applicant: Klafs GmbH, Schwabisch Hall (DE)

(72) Inventor: Markus Gäbele, Schwabisch Hall (DE)

(21) Appl. No.: 18/384,797

(22) Filed: Oct. 27, 2023

(30) Foreign Application Priority Data
Jun. 16, 2023 (EP) 23179754.9

(51) Int. Cl. A45C 11/12

(52) U.S. Cl. CPC A45C 11/12

(57) ABSTRACT

The heat protection element is configured to protect an object that is wearable at the human body, in particular a wrist watch designed as a smartwatch. The heat protection element comprises a fastening section and an insulation section. The fastening section is configured to fasten the heat protection element relative to the object to be protected, and the insulation section is configured to insulate the object from ambient temperature. The heat protection element can be manually separated from the smartwatch to be protected.

### CROSS-REFERENCE TO RELATED APPLICATION

This application claims priority to and the benefit of European Patent Application No. 23179754.9, filed on Jun. 16, 2023, and entitled “HEAT INSULATION OF A WRIST WATCH IN A SAUNA” which is herein incorporated by reference.

### BACKGROUND

### 1. Field

The present disclosure relates to a heat protection element.

### 2. Related Art

Generic heat protection elements can be applied anywhere where the ambient temperature exceeds or falls below the admissible temperature range in particular of small digital units worn at the body and referred to as wearables. Such wearables serve to detect or receive environmental parameters and make these information accessible to their wearers. These environmental parameters can also relate to vital parameters of the human body which often prerequisites wearing the unit directly at the body or having skin contact. A particularly widespread embodiment of a wearable therefore is the smartwatch which is worn by the user as a wrist watch at the wrist.

It is difficult to imagine life without the monitoring and observation of vital parameters, such as heart rate, blood pressure or oxygen saturation, not only for optimizing the training and regeneration from amateur to professional sports, but moreover for minimizing health risks outside the sports field. Possibly, constant monitoring is even required or desirable for other reasons, so that the corresponding smartwatch, the best known representatives of it being Apple Watch and Galaxy Watch, should not be laid down, if possible. A case of application that is difficult under these points of view is a session in a sauna. On the one hand, the high temperatures bring the human body quasi into an exceptional situation in which the collection of vital parameters can be all the more informative. On the other hand, the temperatures of a sauna clearly exceed the admissible field of application of smartwatches.

### SUMMARY

Up to now, no approach has been known from prior art how this conflict could be solved. This is which the present disclosure addresses and therefore makes it its object to provide a heat protection element which insulates wearables and in particular smartwatches from ambient temperature to thus permit a sauna session without having to lay down the smartwatch worn at the wrist.

In the solution according to the disclosure, the heat protection element for protecting an object wearable at the human body, in particular a wrist watch, comprises a fastening section and an insulation section, wherein the fastening section is configured to fasten the heat protection element relative to the object to be protected, and the insulation section is configured to insulate the object from ambient temperature, and the heat protection element can be manually separated from the wrist watch to be protected.

While the present disclosure is primarily directed to the protection of smartwatches in a sauna, these teachings are transferable to various objects wearable around the wrist, such as analogue wrist watches or other electric units wearable at the wrist, and even jewelry worn on the wrist.

The fastening section and the insulation section can be arranged with respect to each other as function sections of the heat protection element in various ways. It is conceivable for the fastening section to completely comprise the insulation section. It is also possible that the fastening section forms a region of the insulation section. As an alternative, the fastening section and the insulation section can be realized in an overlapping manner, but also as two separate, but connectable elements.

The insulation section is designed such that it can insulate the smartwatch from ambient temperature. To be able to wear a smartwatch or a comparable small electronic unit in a sauna, the insulation section in cooperation with the whole heat protection element is designed for the ambient temperature of the smartwatch being kept, in a sauna environment of up to 110° C., below 50° C. for at least 15 minutes. The thermal conductivity λ of the material used for the insulation section is below

$$1 \frac{W}{m K} ,$$

advantageously below

$$0.5 \frac{W}{m K} ,$$

and particularly advantageously below

$$0.1 \frac{W}{m K} .$$

Advantageous embodiments of the present disclosure are the subject matter of the subclaims.

According to an advantageous design of the present disclosure, the fastening section is a textile and stretchable band, the band having a width and the width being larger than the width of the wrist watch to be protected, and wherein the band is configured to completely embrace an arm in the region of the wrist. Advantageously, the stretchable textile band is designed as a stretch band whereby its stretchability goes beyond that of a textile without stretching proportion. The stretchable textile band can have a closed design, wherein its circumference and stretchability are designed such that the band both encloses the smartwatch to be protected and lies against the forearm or the wrist of the wearer so that it cannot slip. However, the stretchable textile band can also have an open design, wherein in this case, an additional closing mechanism is provided to ensure a good seat of the heat protection element at the wrist. For optimal heat protection, the stretchable textile band is wide enough to be wider than the watch housing of the smartwatch to be protected, to completely enclose it and to moreover also provide heat insulation from the environment for the region between the watch housing and the skin. The insulation section can, for example, be realized by a higher material thickness in the described embodiment.

According to a further advantageous embodiment of the present disclosure, the fastening section includes a seat, wherein the seat is configured such that the housing of the smartwatch to be protected is received. The shape of the recess and the shape of the insulation section are advantageously matched such that the insulation section remains positioned in the recess without slipping. The insulation section and the fastening section can be fastened to each other such that a manual separation is no longer possible. For a good temperature insulation of the smartwatch to be protected, it is advantageous for the insulation element to be designed, as concerns its outer dimensions, such that it encloses the watch housing as tightly as possible and across a region as large as possible. To be able to read the detected parameters of a wrist watch designed as a smartwatch during a sauna session, it is then necessary to push down the heat protection element from the smartwatch for a short period.

To facilitate the pushing-down of the heat protection element from the smartwatch and the realignment of the heat protection element, the heat protection element can include a grip region by which the wearer can easily grip the heat protection element.

According to a further advantageous embodiment of the present disclosure, the seat is a continuous recess, and the information displayed on a smartwatch can be read through the recess, wherein the recess can be openable and closable manually by means of a Velcro fastener. In order to be able to read the information provided on the display of the smartwatch if required, the size of the recess corresponds at least to the size of the watch housing of the smartwatch to be protected. The seat designed as a recess can be covered by the insulation section.

According to a further advantageous embodiment of the present disclosure, the insulation section includes a different material than that of the fastening section. Here, a light material with a high specific thermal resistance is advantageous to be able to insulate the smartwatch to be protected as effectively as possible from the temperatures occurring in a sauna. It is conceivable for the insulation section to be formed in the form of a thin layer of a particularly thermally resistant material that is applied on the fastening section from inside.

According to a particularly advantageous embodiment of the present disclosure, the material of the insulation section comprises plastic. It is conceivable that solid plastic is used for the insulation section, and the shape of the insulation section is in accordance with the shape of the watch housing to be protected.

According to a further advantageous embodiment of the present disclosure, the insulation section comprises a transparent material, so that the information displayed on a smartwatch can be constantly read. For this, for example, a transparent and heat-resistant plastic is possible. Basically, however, the use of glass is also conceivable.

According to a further advantageous embodiment of the present disclosure, the insulation section can be manually separated from the fastening section and manually fastened to it. To this end, the recess in the fastening section can comprise, for example, a receiving section, and the insulation section can comprise a clamping region matching the receiving section. In other words, for reading the display, the insulation section, which is designed as a separate element in this embodiment, can be easily removed and placed on or clipped in again by hand.

According to a further advantageous embodiment of the present disclosure, the material of the fastening section comprises silicone, wherein the fastening section is configured such that the heat protection element can be fastened to the wrist like a wrist watch, and wherein the fastening section includes a recess through which the information displayed on a smartwatch can be read, and wherein the insulation section cooperates with the fastening section such that the recess of the fastening section can be opened and closed by clapping the insulation section shut. The fastening section can be designed as a silicone wristband, wherein, for fastening it to the wrist of the wearer, a closure like a wristband of a watch can be provided. However, it is also conceivable for the closure to be designed as a Velcro fastener. To fasten the heat protection element at the wrist, the fastening section can also be designed as a clasp or buckle and the latter is clamped at the wrist. To this end, the fastening section has an open design over a predetermined angular region and is moreover designed such that it can be bent up in a reversible manner.

To securely and tightly close the recess by the insulation section and thereby ensure the thermal protection of the smartwatch, a latching mechanism can be provided apart from the folding mechanism.

According to a further advantageous embodiment of the present disclosure, the heat protection element includes a cooling element. The cooling element can comprise, for example, one or several small cooling packs associated with the insulation element. By the additional active cooling, an even better heat protection can be achieved.

According to a further advantageous embodiment of the present disclosure, the cooling element includes a phase change material. The phase change material passes over from a solid to a liquid state of aggregation as of a certain temperature. It takes the thermal energy required for this from its environment, wherein the thermal energy is stored as long as the temperature is above the melting point of the employed phase change material.

According to a further advantageous embodiment of the present disclosure, the fastening section is designed such that the heat protection element can be fastened to the smartwatch to be protected. Fastening can be accomplished, for example, by clipping the heat protection element onto the smartwatch. In particular, the heat protection element can be clipped onto a housing of the smartwatch. To this end, the fastening section can comprise two clamping sections by means of which the clipping-on is permitted. In particular, the fastening section can include two springy tongues which are latched with a lower edge of the housing, in the clipped-on state, on opposed sides of the housing of the smartwatch.

### BRIEF DESCRIPTION OF THE DRAWINGS

Some embodiments of the present disclosure will be illustrated more in detail below with reference to drawings.

In the following illustrations, equal parts are designated by equal reference numerals. If a figure contains reference numerals which are not discussed in greater detail in the pertaining description of the figures, reference is made to preceding or following descriptions of the figures.

In the drawings:

FIG. 1 shows a representation of an embodiment of the heat protection element according to the disclosure,

FIG. 2 shows a representation of a further embodiment of the heat protection element according to the disclosure,

FIG. 3A shows a representation of a further embodiment of the heat protection element according to the disclosure,

FIG. 3B shows a representation of the embodiment of the heat protection element according to the disclosure according to FIG. 3A in a closed state,

FIG. 4 shows a representation of a further embodiment of the heat protection element according to the disclosure,

FIG. 5A shows a representation of a further embodiment of the heat protection element according to the disclosure,

FIG. 5B shows a schematic sectional representation of the heat protection element according to the disclosure according to FIG. 5A, and

FIG. 6 shows a representation of a further embodiment of the heat protection element according to the disclosure.

### DETAILED DESCRIPTION OF THE ENABLING EMBODIMENT

FIG. 1 shows an embodiment of the heat protection element 1 according to the disclosure comprising a fastening section 2 and an insulation section 3. The heat protection element 1 is designed as a textile stretchable band which the user pulls over his or her wrist to protect his or her smartwatch. To facilitate the putting-on and removing of the heat protection element 1 and the reading of the display of the smartwatch, a grip region 7 is provided. It is obvious that the heat protection element 1 designed as a continuous band is wider than the smartwatch 4 to be protected which is completely covered by the heat protection element 1. The shown embodiment of the heat protection element 1 according to the disclosure is particularly suited to be employed for the heat protection of any possible shapes and sizes of smartwatches, analogue wrist watches and even jewelry.

In the embodiment of the heat protection element 1 according to the disclosure which is described in FIG. 1, the exact design of the insulation section 3 cannot be identified. Thereby, a smooth and unobtrusive design of the heat protection element 1 is achieved. In this case, the insulation section 3 can be designed as a region of a larger material thickness or as an additional layer of a very thermally resistant material applied from inside.

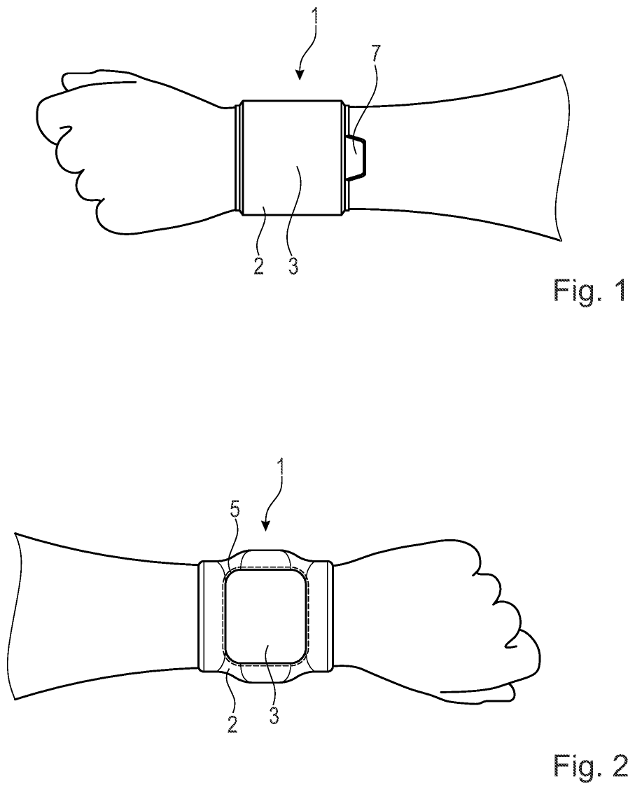

FIG. 2 shows a further embodiment of the heat protection element 1 according to the disclosure with a fastening section 2 designed as a textile and stretchable band, wherein the fastening section 2 includes a recess 5 which is formed to receive the insulation section 3 made of a material different from that of the fastening section 2. In the shown embodiment, the insulation section 3 is glued or sewn to the fastening section 2.

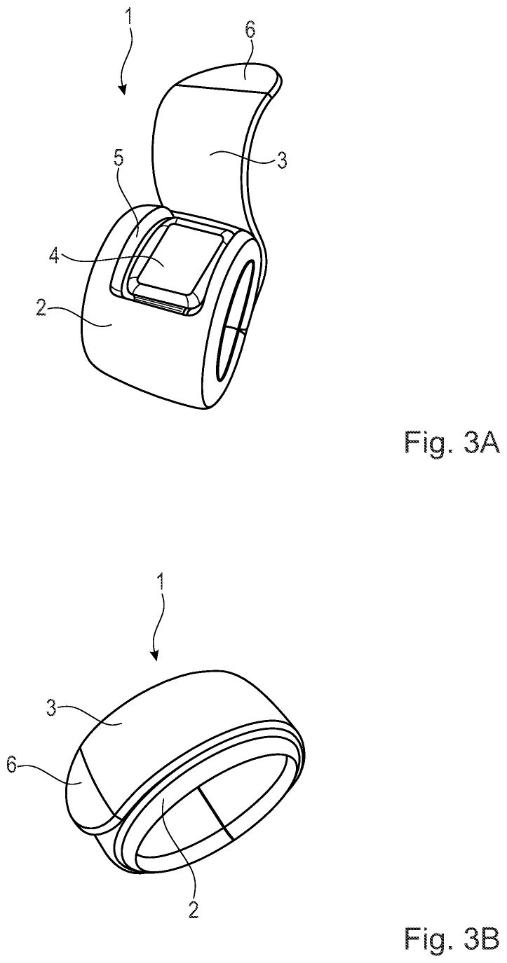

FIGS. 3A and 3B show a further embodiment of the present disclosure with a continuous recess 5 through which the information provided on the display of the smartwatch 4 can be read. The fastening section 2 and the insulation section 3 are designed as a textile band with a large material thickness. To ensure the thermal insulation of the smartwatch 4, the recess can be closed by the insulation section 3 by a Velcro fastener 6. In the shown embodiment, the Velcro fastener 6 can be opened and closed along the circumferential direction of the heat protection element 1. A slightly modified embodiment of the Velcro fastener 6 provides to close and open it in a transverse direction. FIG. 3B shows the heat protection element 1 according to the disclosure of FIG. 3A with a closed Velcro fastener 6.

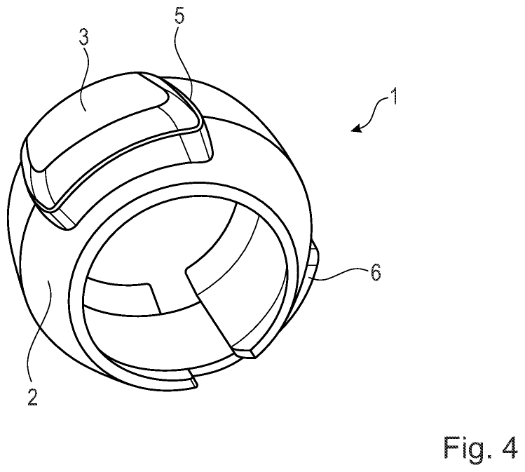

FIG. 4 shows a further embodiment of the heat protection element 1 according to the disclosure, wherein the fastening section 2 is designed as an open band and can be fastened to the wrist of the wearer of the smartwatch 4 to be protected by a Velcro fastener 6. The fastening section 2 includes a continuous recess 5 in which the insulation section 3 designed as a separate element can be manually fastened and removed.

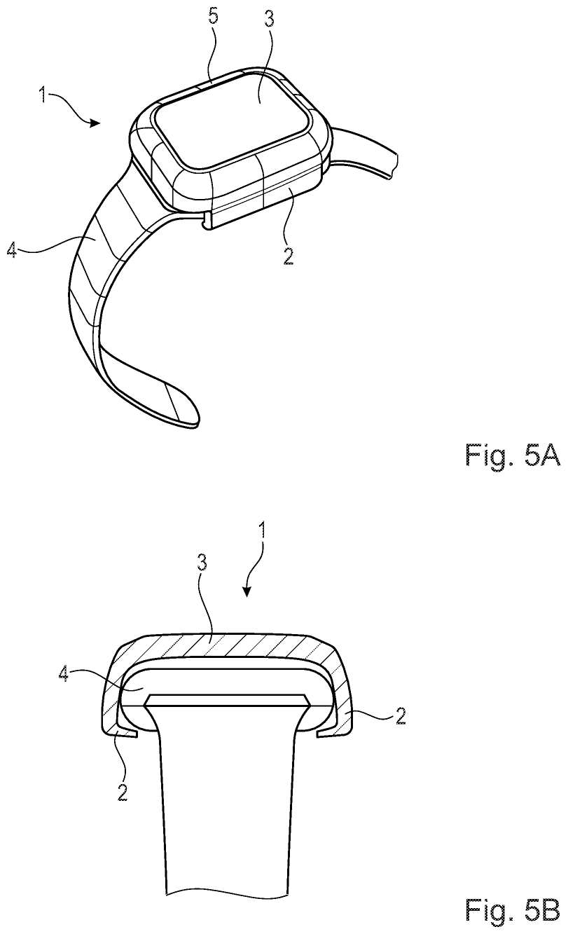

FIGS. 5A and 5B show a further embodiment of the heat protection element 1 according to the disclosure, wherein the fastening section 2 is designed such that the heat protection element 1 can be manually clipped onto the smartwatch 4 to be protected. The insulation section 3 and the fastening section 2 are designed as solid plastic which, however, can be flexible if they have a corresponding material thickness. In this embodiment, the insulation section 2 includes a transparent material, so that the wearer of the smartwatch can read the information indicated on the display at any time. FIG. 5B shows a sectional view of the smartwatch 4 shown in FIG. 5A including the heat protection element 1 according to the disclosure. It is obvious how the fastening section 2 encloses the smartwatch 4 to be protected and thereby not only ensures a tight seat of the heat protection element 1 on the smartwatch 4, but moreover contributes to the insulation of the smartwatch 4 from the environment.

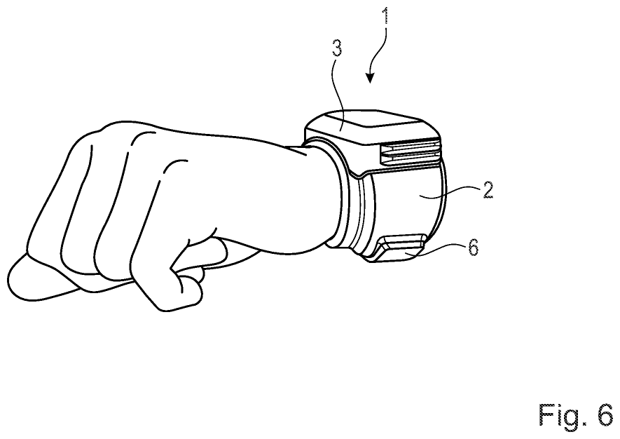

FIG. 6 shows a further embodiment of the heat protection element 1 according to the disclosure, wherein the fastening section 2 is designed as a silicone wristband and can be fastened to the wrist by means of a Velcro fastener 6. The insulation section 3 is formed of plastic and closes the recess 5 in the fastening section 2 not visible in the representation of FIG. 6 like a cover. The insulation section 3 can be folded away from the fastening section 2 and clears the view onto the display of the smartwatch 4 in its opened state. To realize the folding mechanism, the insulation section has a two-piece design, wherein a frame part is firmly provided on the fastening section and forms the immobile part of the folding mechanism or the counter part to the flap, respectively. The upper part designed as a flap is articulated with the frame part and can be opened and closed relative to the frame part. In this embodiment it is also visible that the fastening section 2 is designed so wide that an additional contribution to the thermal insulation of the smartwatch 4 to be protected is given.

1. A heat protection element for protecting an object wearable at the human body, in particular a wrist watch designed as a smartwatch, the heat protection element comprising:
a fastening section and an insulation section,
the fastening section being configured to fasten the heat protection element relative to the object to be protected,
the insulation section being configured to insulate the object from ambient temperature, and
wherein the heat protection element can be manually separated from the smartwatch to be protected.

2. The heat protection element according to claim 1, wherein the fastening section is a textile and stretchable band, wherein the band has a width and the width is larger than the width of the smartwatch to be protected, and wherein the band is configured to completely embrace an arm in the region of the wrist.

3. The heat protection element according to claim 1, wherein the fastening section includes a seat, and wherein the seat is designed such that the housing of the smartwatch to be protected is received.

4. The heat protection element according to claim 3, wherein the seat is a continuous recess, and the information displayed on a smartwatch can be read through the recess, wherein the recess is manually openable and closable by means of a Velcro fastener.

5. The heat protection element according to claim 1, wherein the insulation section includes a different material from that of the fastening section.

6. The heat protection element according to claim 5, wherein the material of the insulation section is plastic.

7. The heat protection element according to claim 1, wherein the insulation section comprises a transparent material, so that the information displayed on a smartwatch can be constantly read.

8. The heat protection element according to claim 1, wherein the insulation section can be manually separated from and manually fastened to the fastening section.

9. The heat protection element according to claim 1, wherein the material of the fastening section comprises silicone,
wherein the fastening section is configured such that the heat protection element can be fastened to the wrist like a smartwatch, and wherein the fastening section includes a recess through which the information displayed on a smartwatch can be read, and
wherein the insulation section cooperates with the fastening section such that the recess of the fastening section is openable and closable by clapping the insulation section shut.

10. The heat protection element according to claim 1, wherein the heat protection element includes a cooling element.

11. The heat protection element according to claim 10, wherein the cooling element comprises a phase change material.

12. The heat protection element according to claim 1, wherein the fastening section is designed such that the heat protection element can be fastened to the smartwatch to be protected.

13. The heat protection element according to claim 12, wherein the heat protection element can be clipped onto a housing of the smartwatch.

14. The heat protection element according to claim 13, wherein the fastening section includes two springy tongues which are latched with a lower edge of the housing, in the clipped-on state, on opposed sides of the housing of the smartwatch.
